(19) United States
(12) Patent Application Publication
(10) Pub. No.: US 2004/0133393 A1
(43) Pub. Date: Jul. 8, 2004

(54) PREDICTION SYSTEM BASED ON WEIGHTED EXPERT OPINIONS USING PRIOR SUCCESS MEASURES

(75) Inventor: GEORGE MISIUM, DALLAS, TX (US)

Correspondence Address: ENOVUS, SUITE #230, 7601 CHURCHILL WAY, DALLAS, TX, 75251, US

(73) Assignee: ENOVUS INC., DALLAS, TX (US)

(21) Appl. No.: 10/707,680

(22) Filed: Jan. 4, 2004

Related U.S. Application Data
(60) Provisional application No. 60/319,835, filed on Jan. 4, 2003.

(51) Int. Cl. G06F 15/00

(52) U.S. Cl. 702/181

(57) ABSTRACT

This invention is a prediction and reward system and method based on pooling the opinions of experts by using quantitative measures of prior prediction performance to weigh the opinions. This invention enables a computer-network based system capable of generating predictions based on expert opinions as well as measures of expert performance.

### BACKGROUND OF INVENTION

The present invention relates to prediction systems based on expert opinions.

This invention enables the prediction of multiple events including, and not limited to, financial parameter performance (e.g. stock and bond prices, interest rates, currency exchange rates), sport events (e.g. scores, standings), natural phenomena (e.g. weather, resource level), and fuzzy events (e.g. speech and pattern recognition). In the context of this description, an expert is defined as any entity capable of putting forward an answer or opinion to the likelihood or quantitative value of an event. Therefore, experts would include human beings of varying degrees of skill and expertise as well as machines or devices capable of putting forward an answer or opinion. In the realm of machine applications, the use of independently trained classifiers and the aggregation of their outputs is commonplace in technologies such as speech and pattern recognition.

An event or the probability of an event occurring can be predicted according to different techniques, some more formal than others, ranging from deterministic simulation models to intuitive predictions. Standard formal prediction techniques include extrapolation, pattern analysis, and methods relying on the pooling of expert opinions. Prediction methods relying on expert opinions are common-place and ancient. Calling upon an oracle or the reading of tea leaves are what we could call informal approaches to predicting an event by relying on expert opinions. Among more rigorous approaches, the most prevalent method to elicit and aggregate the opinion of experts is the “Delphi Technique”developed by the RAND Corporation for the Air Force in the 1950's. According to this technique, a number of experts are asked to submit anonymous opinions on a particular future event. As an example, an early forecasting study using the Delphi Technique asked the question “In what year will the percentage of electric automobiles among all automobiles in use reach 50%?”The Delphi Technique generally includes several rounds of inquiry with controlled feedback to the experts in order to reach consensus on a prediction. The prediction generated by the Delphi Technique is a statistically based group response.

Other methods for eliciting expert opinions as to an event occurring include conferencing methods. On-line conferencing and workgroups have received particular attention recently. Exploratory modeling is another method, here a very large number of future scenarios is generated and evaluated by experts from a decision-making perspective.

A fundamental problem with existing approaches to the prediction of events based on expert opinions is the need to ultimately make subjective calls that may hamper the end result. Foremost among these subjective calls, is the need to choose the experts from whom opinions are elicited. No matter how carefully experts are chosen, there is a chance of integrating experts whose opinions are unreliable and, worse yet, there is the certainty of leaving out experts whose opinion may be crucial to the predictive process.

Another flaw in existing approaches is the use of subjective measures to pool the opinion of experts. Experts may disagree and our perception of the quality of the opinion of a particular expert may be wrong. The simplest approach to aggregating or pooling opinions is simply to average all opinions to calculate a predicted value or likelihood of an event. As mentioned, in the Delphi Technique several rounds of inquiry seek to coalesce the opinion of experts. This approach has been shown to work efficiently when the sources of error for different experts are independent. This constraint is clearly not met in the case of most experts, particularly humans. This may deviate the final prediction further from its true outcome, especially when far-from-average opinions are eliminated. The use of weights to integrate an expert's opinion to a body of personal knowledge is intuitive and is done on a daily basis. Weighting expert opinions to calculate a final prediction has been used with methods such as the Delphi Technique. This approach raises, once again, the issue of making subjective calls in that weights may be assigned to expert opinions in an arbitrary manner often as part of the initial process of selecting the experts.

### SUMMARY OF INVENTION

The primary object of this invention is to enable a system capable of predicting an event based on the pooling of expert opinions by using different quantitative measures of prior prediction performance to weigh each expert opinion. This invention not only allows for a better final prediction but also permits the integration of outside or less sought after experts.

A second object of this invention is to enable a measure of an expert's performance, which may be used as a means of reward or disincentive. In the case of human experts, the very basic urge to second-guess or “armchair coach” can not only be satisfied by this invention but also properly rewarded in the case of accurate predictions.

Another object of this invention is to enable a system for decision making and of participatory rewards based on eliciting and polling the opinion of experts over the Internet or over any other extended computer network such as those internal to many organizations.

A further object of this invention is to enable apparatuses based on this method and capable of integrating different inputs weighted by prior performance when predicting the outcome of an event.

The first aspect of the present invention is a system comprising a means to elicit expert opinions, a means to store prior expert opinions, a means to calculate measures of prior performance by the experts, a means to pool the opinions weighted by these measures of prior performance, and a means to issue predictions and expert performance measures.

The second aspect of the present invention is a method comprising the steps of eliciting and receiving expert opinions, storing measures of prior performance, pooling expert opinions weighted by these prior performance measures according to an algorithm described below, issuing predictions, tracking actual outcome of events, and updating the measure of performance for each expert.

In accordance with a preferred embodiment of this invention, a prediction and reward system operates over a computer network by eliciting opinions from experts and issuing predictions and measures of expert performance. The expert opinions are weighted by a measure of prior performance and the weighted opinions are arithmetically averaged. In this preferred embodiment, the measure of prior expert performance is the average of inverse exponentials of absolute differences between prior expert opinion and actual event outcome. This average of inverse exponentials is a summation of inverse exponentials arithmetically factored by their time-series position in the sequence of previous opinions. Further the individual weights assigned to expert opinions are normalized by the same factor to make the sum of all weight equals to 1.

An alternate embodiment may be realized by using a different pooling algorithm from the preferred arithmetic average such as a weighted geometric average, weighted harmonic average, and other forms of weighted averages.

In a second alternate embodiment of this invention, the inverse exponential of absolute differences between expert opinion and outcome is replaced by another mathematical function monotonously decreasing with the amount of absolute deviation between expert opinion and outcome.

In another alternate embodiment, the measure of prior performance by the expert is first evaluated based on a test using historical data.

A further alternate embodiment of this invention is a system where the first measure of an expert's performance is based on a mapping of prior prediction capabilities in a different realm of activity. For instance, an expert being utilized for the first time to offer predictions on future stock prices may have a starting weight factor based on her performance predicting bond prices.

Yet further alternate embodiments may be realized when operational analysis techniques or neural networks are used to determine the weights associated to the prior performance of experts.

The above and other objects, features, and advantages of this invention will become apparent to, or may be learned by practice of the invention, by any person skilled in the art from this description in conjunction with the accompanying drawings in which preferred embodiments of the present invention are described and shown by way of illustrative examples.

### BRIEF DESCRIPTION OF DRAWINGS

FIG. 1 is a block diagram of a prediction and reward system according to a preferred embodiment of the invention.

FIG. 2 is a flow diagram of a method for eliciting, weighting, and pooling expert opinions and for issuing predictions.

FIG. 3 is a flow diagram of a method for eliciting, weighting, and pooling expert opinions and for issuing predictions and expert performance measures

FIG. 4 displays the results of applying this invention's method as well as that of the prior art to the prediction of stock market performance

FIG. 5 displays the accumulated error of this invention's method against that of the prior art for the example in FIG. 4

### DETAILED DESCRIPTION

Reference is now made to the drawings. Corresponding reference numbers are used throughout the figures to designate corresponding elements.

The following is a description of illustrative embodiments and should not be construed in a limiting sense. Modifications of the illustrative embodiments will be apparent to a person having ordinary skills in the art.

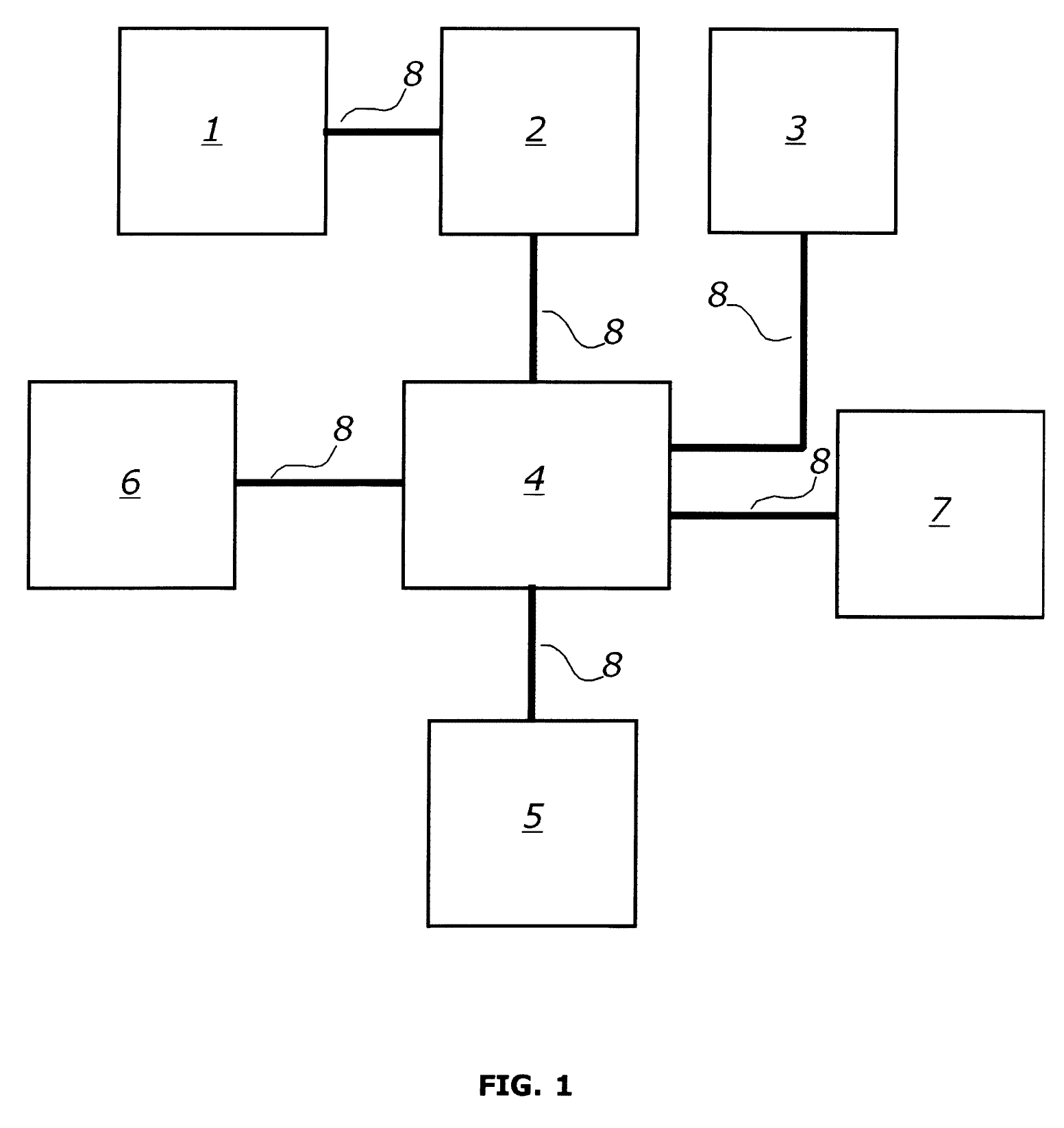

FIG. 1 is a block diagram block of a prediction and reward system according to a preferred embodiment of the invention. The prediction and reward system comprises an input means 1 for experts to enter their opinions on an event outcome by responding to specific questions from input means 1. Register means 2 for capturing the data transmitted from input means 1. Storage means 3 for storing measures of prior performance by different experts. Processing means 4 for processing the data registered by register means 2 and the data stored in storage means 3. Processing means 4 weights the input opinion from experts stored in register means 2 by the corresponding measure of prior expert performance stored in storage means 3. Upon calculating a prediction based on the pooling of the weighted expert opinions, processing means 4 transmits the prediction to output means 5. Input means 6 tracks the actual outcome of the predicted event and transmits the data to processing means 4. Processing means 4 compares the actual outcome of the event to the individual expert opinions, recalculates the expert performance weight, and transmits the recalculated weight to storage means 3 to be used as new measure of expert prior performance. Input/Output means 7 receives external inquiries on prior expert performance and upon validation by processing means 4 it issues measures of prior expert performance. Interconnect means 8 allow the transmission of data and other signals among all the components.

Input means 1 in this preferred embodiment is a website displaying specific questions and capable of validating the identity and capturing the opinion of an expert. Means 2, 3, and 4 are respectively computer-based register, memory, and processing means. Means 5, 6, and 7 are in the preferred embodiment email-based systems for the transmission of information to and from the prediction system. Further integration of the system may be achieved by making any or all of means 1 through 8 part of a single website.

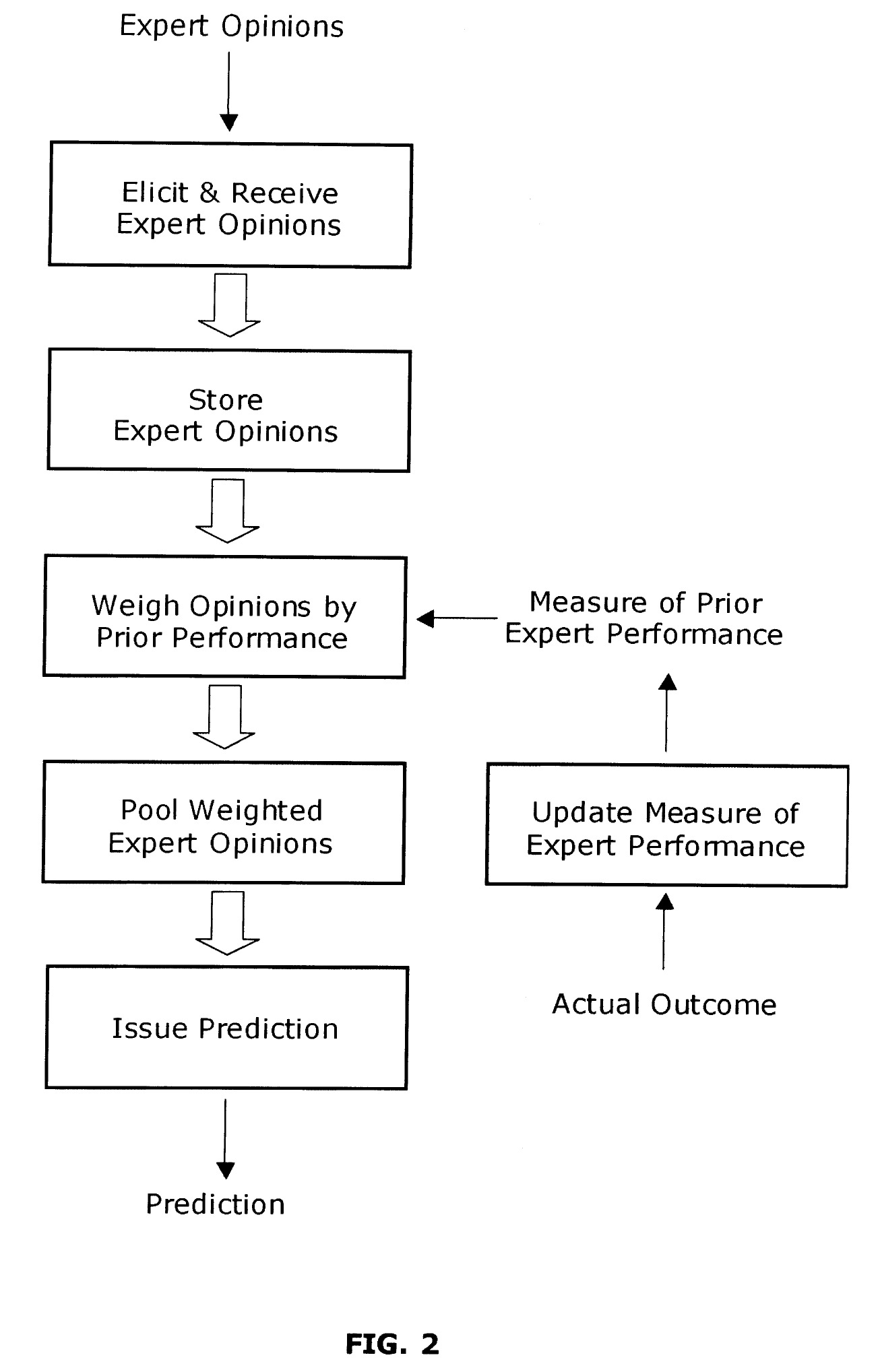

FIG. 2 is a flow diagram of a method for eliciting, weighting, and pooling expert opinions and for issuing predictions. The method comprises the following steps: Elicit and receive expert opinions. Store these expert opinions. Weigh the expert opinions by measures of prior performance. Pool the weighted opinions. Issue a prediction resulting from the pooling of weighted opinions. Update the measures of expert performance by comparing the expert prediction to the actual outcome of the event.

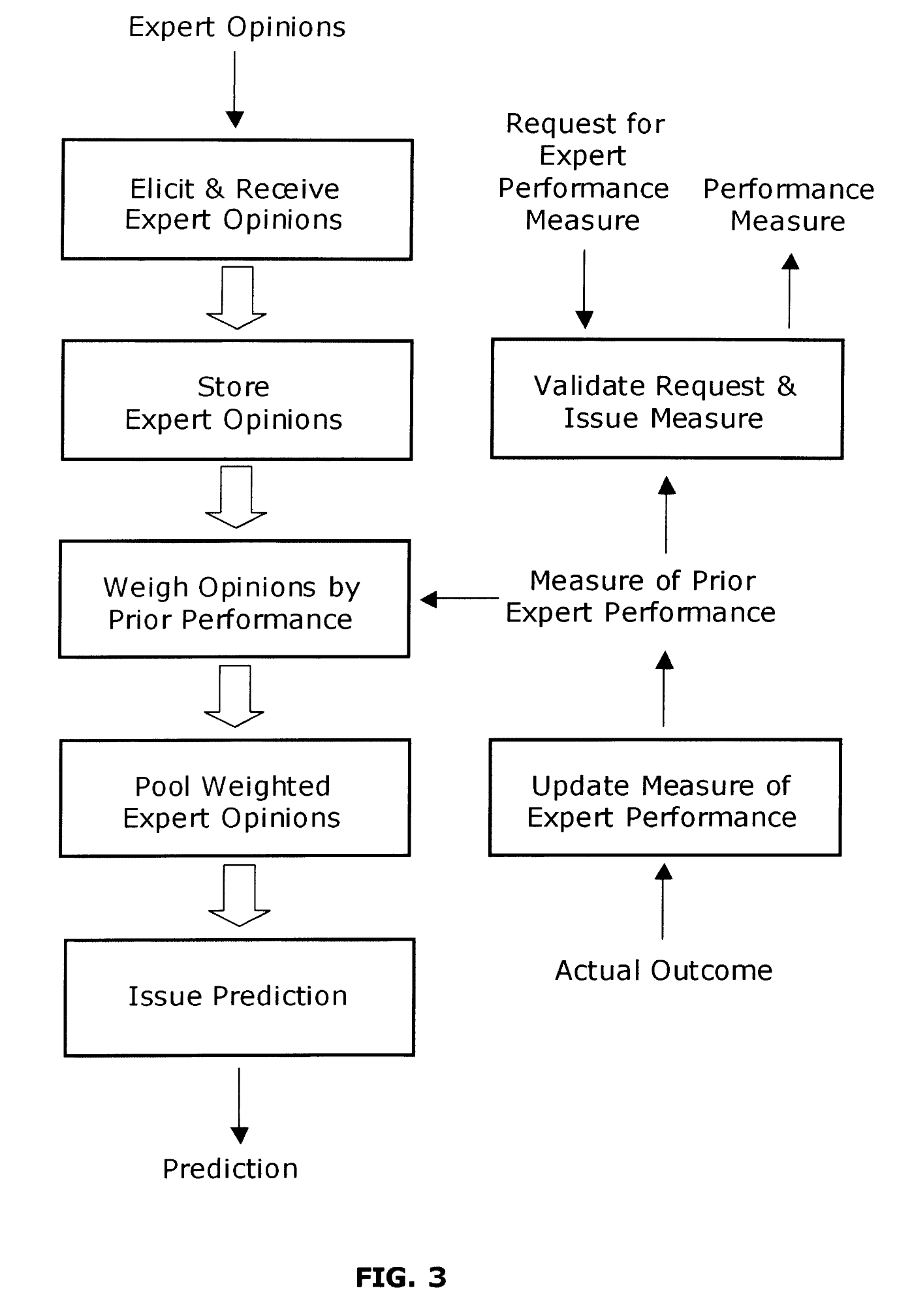

FIG. 3 is a flow diagram of a method for eliciting, weighting, and pooling expert opinions and for issuing predictions and expert performance measures. In addition to the steps comprising the method described in FIG. 2, this method comprises the step of issuing a measure of an expert's prior performance upon validating a request for performance measure.

In what follows an illustrative embodiment is described in detail. In this illustrative embodiment, a prediction system for the Down Jones Industrial Average of stock prices (“DJI”) is described and its performance compared to prior art techniques. The object of this system is to predict the value of the DJI one month in advance. For that purpose, ten experts are to submit their opinion on the value of the DJI not later than 21 trading days before a given date. In this example, the ten experts are (for illustration purposes non-intelligent experts are chosen), simple algorithms based on the analysis of historical data as shown in Table 1.

TABLE 1

| EXPERT | OPINION ALGORITHM FOR DJI |
|---|---|
| NUMBER | VALUE IN 21 TRADING DAYS |
| 1 | Aggressive bull: Market up 5% |
| 2 | Aggressive bear: Market down 5% |
| 3 | Historical: Market up 1% over |
| | average for last 21 days |
| 4 | Market trend for last 21 days |
| | will continue to hold true |
| 5 | Market trend for last 21 days |
| | will be reversed |
| 6 | Market trend for last quarter |
| | will continue to hold true |
| 7 | Market trend for last quarter |
| | will be reversed |
| 8 | Market trend for last year |
| | will continue to hold true |
| 9 | Market will stand at same |
| | value as one quarter ago |
| 10 | Market will stand at same |
| | value as one year ago |

The predicted DJI value in 21 trading days was first calculated according to prior art technique; that is, the predicted DJI value was calculated as the arithmetic average of the 10 expert opinions. Next, the predicted DJI value in 21 trading days was calculated according to the method of this invention.

First, for each day when expert number j had an opinion for the actual DJI value, a raw weight Wⱼ was calculated as the inverse exponential of the absolute difference between the expert opinion Oⱼ and the actual DJI value D, as represented by Formula 1.

Wⱼ=exp[−abs(Oⱼ−D)] [Formula 1]

Second, a normalizing factor F was calculated by adding all weights Wⱼ, as shown in Formula 2.

F=SUM[₁:W₁₀] [Formula 2]

Third, normalized weights Wⱼ were calculated by dividing the raw weights Wⱼ by the normalizing factor F, as in Formula 3.

Wⱼ=Wⱼ/F [Formula 3]

Fourth, for expert number j a measure of prior performance mⱼ was calculated as the summation of inverse exponentials wⱼ arithmetically factored by their time-series position in the sequence of previous ten opinions as calculated in Formula 4 where wⱼ₁ is the latest weight for expert j, wⱼ₂ is the second to last weight and so on to wⱼ₁₀ which is the weight for expert j ten trading days earlier.

mⱼ=(10*wⱼ₁+9*wⱼ₂+ . . . +2*wⱼ₉+wⱼ₁₀)/55 [Formula 4]

Formula 4 can be expressed in general terms as in Formula 5 with N being 10 for the example above.

mⱼ={2/[(N+1)*N]}*SUM {[10*wⱼ₁]:[(11−N)*W_{jN}]} [Formula 5]

Finally, expert j opinion Oⱼ is weighted by the measure of prior performance m and all weighted opinions are arithmetically averaged to calculate a predicted value P for the DJI as shown in Formula 6.

P=SUM [(m₁*O₁):(m₁₀*O₁₀)] [Formula 6]

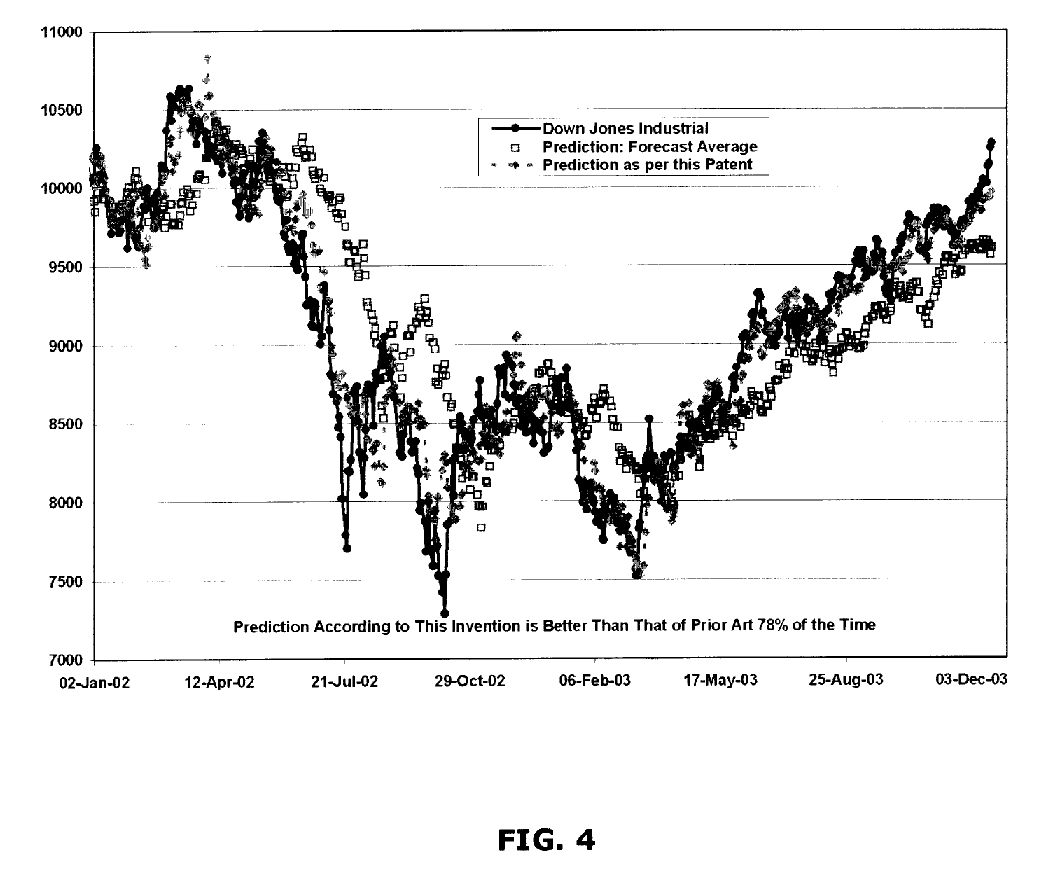

FIG. 4 displays the results of applying to the method of this invention as well as that of the prior art. The actual values of the DJI for the years 2002 and 2003 are shown as small circles linked by a solid line. The 21-trading-day predicted values according to the prior art are shown as open squares. The 21-trading-day predicted values according to this invention and calculated as the “P” values above are shown as diamonds linked by a short-dash line. It is clear that the results from this invention outperform those of the prior art. In fact, the prediction according to this invention is better than that according to the prior art 78% of the time for the period considered.

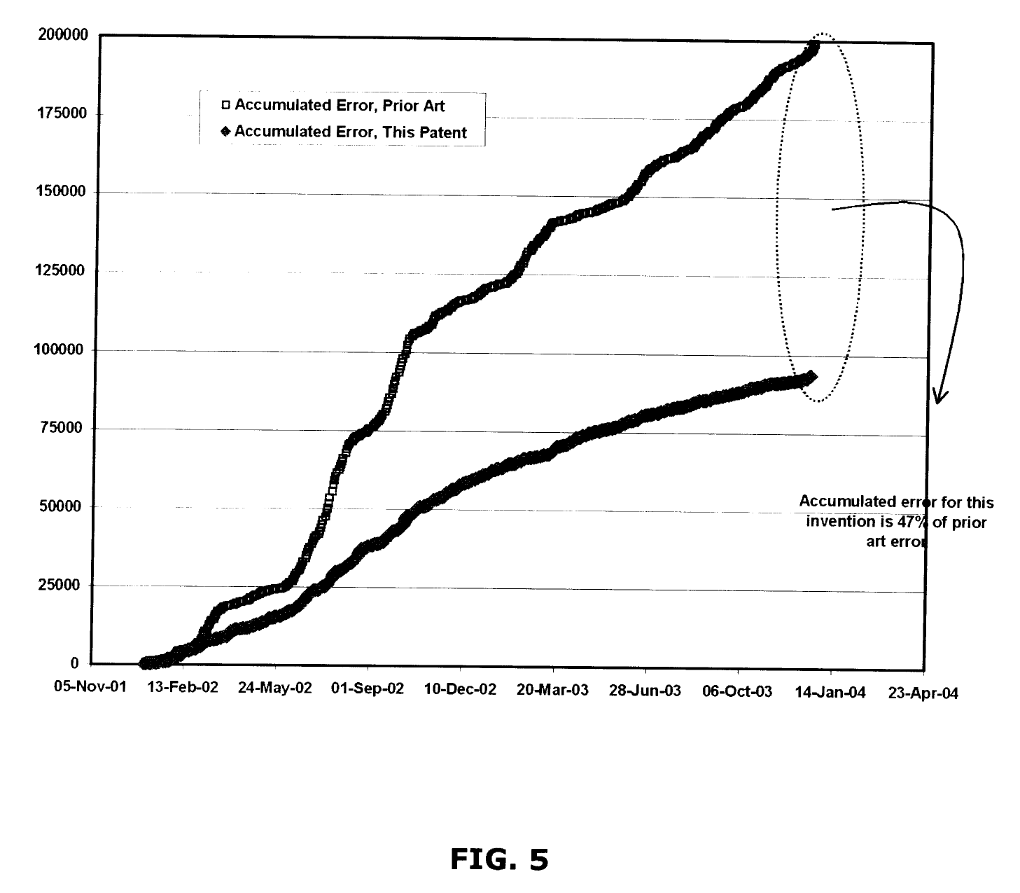

A further assessment of the advantage of this invention is shown in FIG. 5 where the accumulated error of the prediction according to this invention is 47% of that according to the prior art. The accumulated error for this invention is less than that according to the prior art at all times.

With regard to success measures, Table 2 summarizes the experts performance for the period considered. Notice that in the case of a non-weighted arithmetic average, the equivalent expert measure would be 0.1 for all experts. Here expert measures display a large range of values (0 to 0.62) with some experts tending to dominate the overall prediction. Experts 6 (“Market trend for last quarter will continue to hold true”), 1 (“Aggressive bull: Market up 5%”), and 3 (“Historical: Market up 1% over average for last 21 days”) show the largest average success measures. Experts 2 (“Aggressive bear: Market down 5%”) and 8 (“Market trend for last year will continue to hold true”) show very low success measure. This quantitative information is an invaluable tool to evaluate expert performance.

TABLE 2

| | | ST. | MINI- | | |
|---|---|---|---|---|---|
| | | DEV. | MUM | | |
| EXPERT | AVERAGE | MEAS- | MEAS- | MAXIMUM | EXPERT |
| NUMBER | MEASURE | URE | URE | MEASURE | RANKING |
| 1 | 0.18 | 0.16 | 0.01 | 0.62 | 2 |
| 2 | 0.01 | 0.01 | 0.00 | 0.08 | 10 |
| 3 | 0.18 | 0.14 | 0.00 | 0.55 | 3 |
| 4 | 0.16 | 0.13 | 0.00 | 0.45 | 4 |
| 5 | 0.08 | 0.09 | 0.00 | 0.36 | 7 |
| 6 | 0.19 | 0.16 | 0.00 | 0.54 | 1 |
| 7 | 0.10 | 0.09 | 0.00 | 0.32 | 6 |
| 8 | 0.02 | 0.05 | 0.00 | 0.25 | 9 |
| 9 | 0.06 | 0.13 | 0.00 | 0.51 | 8 |
| 10 | 0.13 | 0.14 | 0.00 | 0.59 | 5 |

More predictable events than stock market performance and the use of intelligent experts allow for heightened performance by this prediction system and method.

1 A system for predicting the outcome of an event comprising: input/output means; memory means; processing means; means for experts to enter their opinions on said event outcome into said input/output means; means for capturing the data from said input/output means; means for storing measures of prior performance by different experts in said memory means; means for calculating a prediction for the outcome of said event based on the average of said expert opinions weighted by said measures of prior performance; and means for storing in said memory means and for transmitting to said input/output means the prediction calculated by said processing means:

2 A system according to claim 1, wherein said expert opinions are prompted by said input/output means by asking questions from said experts.

3 A system according to claim 1, wherein said processing means compares the actual outcome of the event to the individual expert opinions, recalculates the expert performance weight, and transmits the recalculated weight to said memory means to be used as new measure of expert prior performance.

4 A system according to claim 1, wherein said input/output means receives external inquiries on prior expert performance and, upon validation by said processing means, issues measures of prior expert performance.

5 A system according to claim 4, wherein said measures of prior expert performance are recalculated by said processing means into participatory rewards or penalties.

6 A system according to claim 1, wherein said input/output means, memory means, and processing means are part of a computer environment internal to an organization or connected to the Internet.

7 A system according to claim 1, wherein said input/output means is a website displaying specific questions, validating the identity and capturing the opinion of an expert, and issuing measures and rewards based on expert performance.

8 A method for issuing predictions on the outcome of an event comprising the steps of: eliciting and receiving expert opinions; storing said expert opinions; weighing said expert opinions by measures of expert prior performance; pooling the weighted opinions; and issuing a prediction resulting from the pooling of weighted opinions.

9 A method according to claim 8 wherein: said measures of expert performance are updated by comparing the expert predictions to the actual outcome of the event.

10 A method according to claim 8 wherein: said experts are human beings of varying degrees of skill and expertise.

11 A method according to claim 8 wherein: said experts are devices capable of putting forward an answer or opinion.

12 A method according to claim 11 wherein: said devices are classifiers used for speech or pattern recognition.

13 A method according to claim 8 wherein: said pooling of weighted opinions is a mathematical average.

14 A method according to claim 8 wherein: said pooling of weighted opinions is an arithmetic average with individual weights assigned to expert opinions normalized by the same factor to make the sum of all weight equals to 1.

15 A method according to claim 8 wherein: said measure of prior expert performance is a mathematical function monotonously decreasing with the amount of deviation between expert opinion and outcome.

16 A method according to claim 8 wherein: said measure of prior expert performance is an average of inverse exponentials of absolute differences between prior expert opinion and actual event outcome.

17 A method according to claim 16 wherein: said average of inverse exponentials is a summation of inverse exponentials arithmetically factored by their time-series position in the sequence of previous opinions.

18 A method according to claim 8 wherein: said measure of prior performance by the expert is first evaluated based on a test using historical data.

19 A method according to claim 8 wherein: said measure of prior performance is based on a mapping of prior prediction capabilities in a different realm of activity.

20 A method according to claim 8 wherein: said weighing of prior performance of experts is realized utilizing operational analysis techniques or neural networks.

21 A method according to claim 8 further comprising: issuing a measure of an expert's prior performance upon validating a request for performance measure.

22 A method according to claim 8 further comprising: calculating an expert's reward or penalty based on said measure of an expert's prior performance.
